(19) United States
(12) Patent Application Publication
(10) Pub. No.: US 2012/0180348 A1
(43) Pub. Date: Jul. 19, 2012

(54) REUSABLE GREETING CARD AND METHOD

(75) Inventor: James A. Keefe, Hudson, OH (US)

(73) Assignee: Forever Cards LLC, Fort Lauderdale, FL (US)

(21) Appl. No.: 13/350,770

(22) Filed: Jan. 14, 2012

Related U.S. Application Data
(60) Provisional application No. 61/432,663, filed on Jan. 14, 2011.

(51) Int. Cl. G09F 1/04

(52) U.S. Cl. 40/124.04; 40/124.191; 40/124.06

(57) ABSTRACT

Provided is a reusable greeting card that includes a forward cover, and a replaceable decorative placard with an externally-exposed surface that is to be outwardly displayed adjacent to the forward cover to be viewable by a viewer observing the greeting card. The decorative placard includes a decoration specific to a theme of the greeting card. A support interchangeably receives the decorative placard and at least a second decorative placard to be outwardly displayed adjacent to the forward cover. The second decorative placard has a second decoration specific to a second theme that is different from the theme of decorative placard. A plurality of writing pages on which customized greeting content is to be applied by a user is also provided to the greeting card. The writing pages are at least partially concealed from view by the forward cover.

### CROSS-REFERENCE TO RELATED APPLICATIONS

This application claims the benefit of U.S. Provisional Application No. 61/432,663, filed Jan. 14, 2011, which is incorporated in its entirety herein by reference.

### BACKGROUND OF THE INVENTION

1. Field of the Invention

This application relates generally to greeting cards and, more specifically, to a reusable greeting card that can optionally include user-customizable features that are customizable by a first user to be sent to a second user, and vice versa, in a plurality of iterations.

2. Description of Related Art

Traditional greeting cards have commonly included a fixed-content forward cover bearing a graphic related to the occasion for which the greeting card is to be sent. Inside, traditional greeting cards often included pre-printed text conveying a kind thought or greeting to the intended recipient of the greeting card. The graphic appearing on the forward cover and the text inside of the greeting card are fixed, generic content created by a vendor of the greeting card to be sold in large volumes. Such greeting cards lack a personalized touch that may mean more to the recipient than the standard graphic and text.

Traditional greeting cards are also used just once, to offer the well wishes of a sender to a recipient or to otherwise mark a special occasion. For example, a birthday card is commonly sent to wish a recipient a happy birthday close to the recipient's birthday. Likewise, seasonal greeting cards are often sent by senders to wish a recipient a happy holiday season. Such greeting cards, however, have limited space for the sender to enter a personalized greeting, and lack space for the recipient to enter a personalized response to the senders thought. Further, these conventional greeting cards are not applicable to be re-sent by the recipient to commemorate a different occasion, other than the one celebrated by the sender who originally sent the greeting card. For example, a birthday card received by a recipient has a theme that prevents the birthday card from being re-sent to another recipient (possibly the original sender) to celebrate Halloween. Such disposable greeting cards thus have a limited lifespan and are typically disposed of shortly after the occasion marked by the fixed theme of the greeting card.

### BRIEF SUMMARY OF THE INVENTION

According to one aspect, the subject application involves a reusable greeting card including an adaptable theme. The reusable greeting card includes a forward cover, and a replaceable decorative placard with an externally-exposed surface that is to be outwardly displayed adjacent to the forward cover to be viewable by a viewer observing the greeting card. The decorative placard includes a decoration specific to a theme of the greeting card. A support interchangeably receives the decorative placard and at least a second decorative placard to be outwardly displayed adjacent to the forward cover. The second decorative placard has a second decoration specific to a second theme that is different from the theme of decorative placard. A plurality of writing pages on which customized greeting content is to be applied by a user is also provided to the greeting card. The writing pages are at least partially concealed from view by the forward cover.

According to another aspect, the subject application involves a A reusable greeting card that includes a forward cover, and a photograph mount adapted to receive a photograph and support the photograph adjacent to the forward cover in a position to be viewed during observation of the forward cover in a closed orientation. A plurality of writing pages on which customized greeting content is to be applied by a user are also provided, and are at least partially concealed from view by the cover. A rearward cover is at least partially separated from the forward cover by the writing pages while the greeting card is in a closed state. A magnet is also coupled to the rearward cover, and establishes a suitable magnetic attraction between the greeting card and a vertically-oriented ferromagnetic material to couple the greeting card to the ferromagnetic material.

According to another aspect, the subject application involves a reusable greeting card. The reusable greeting card includes a forward cover, and a replaceable decorative placard comprising an externally-exposed surface that is to be outwardly displayed adjacent to the forward cover to be viewable by a viewer observing the greeting card. The decorative placard includes a decoration specific to a theme of the greeting card. A support interchangeably receives the decorative placard and at least a second decorative placard with a second decoration specific to a second theme that is different from the theme of decorative placard. A plurality of writing pages on which customized greeting content is to be applied by a user are also provided, and are at least partially concealed from view by the forward cover. A rearward cover coupled to the forward cover is at least partially separated from the forward cover by the writing pages while the greeting card is in a closed state. A storage pouch stores physical objects to be conveyed within the greeting card while in transit between a sender of the greeting card and a recipient of the greeting card. The storage pouch includes a closing mechanism that is adjustable to allow repeated opening and closing of the storage pouch.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows illustrative examples of reusable greeting cards, each with a different themed object in the form of a frame surrounding a photograph window through which a user-supplied photograph is visible;

FIG. 2 shows an illustrative example of a photograph mount that is accessible from an inward-facing side of a forward cover of a reusable greeting card, the photograph holder comprising a sleeve for receiving a photograph to be visible when viewing an exterior side of the forward cover;

FIG. 3 shows an illustrative example of a resealable storage pouch that can be provided to a reusable greeting card for storing one or more items to be conveyed between a sender and a recipient with the reusable greeting card;

FIG. 4 shows an illustrative embodiment of a reusable greeting card including a plurality of content pages secured to the greeting card by a releasable fastener;

FIG. 5 shows an illustrative embodiment of a of a rearward cover of a reusable greeting card, the rearward cover including a support for propping the reusable greeting card in an upright orientation and a magnetic hanger for magnetically coupling the reusable greeting card to a vertically-oriented supporting surface;

FIG. 6 shows an illustrative example of a rearward cover of a reusable greeting card 12 including a support for propping the reusable greeting card in an upright orientation and a hanger for hanging the reusable greeting card from a supporting surface;

FIG. 7 shows an illustrative embodiment of an optional audible page for recording and playing back a message spoken by a user and intended for a recipient;

FIG. 8 shows an illustrative embodiment of a computer system for customizing and optionally purchasing a card;

FIG. 9 shows an illustrative embodiment of a decorative placard arranged for insertion into a sleeve;

FIG. 10 shows an illustrative embodiment of a forward cover of a greeting card extending into a sleeve that also contains a decorative placard;

FIG. 11 shows a side view of an illustrative embodiment of a forward cover of a greeting card and a plurality of decorative placards disposed within a sleeve; and

FIG. 12 shows views of an illustrative example of an inward-facing portion of a forward cover of a reusable greeting card including a user-accessible sleeve for receiving an object and a releasable clasp for binding content pages.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

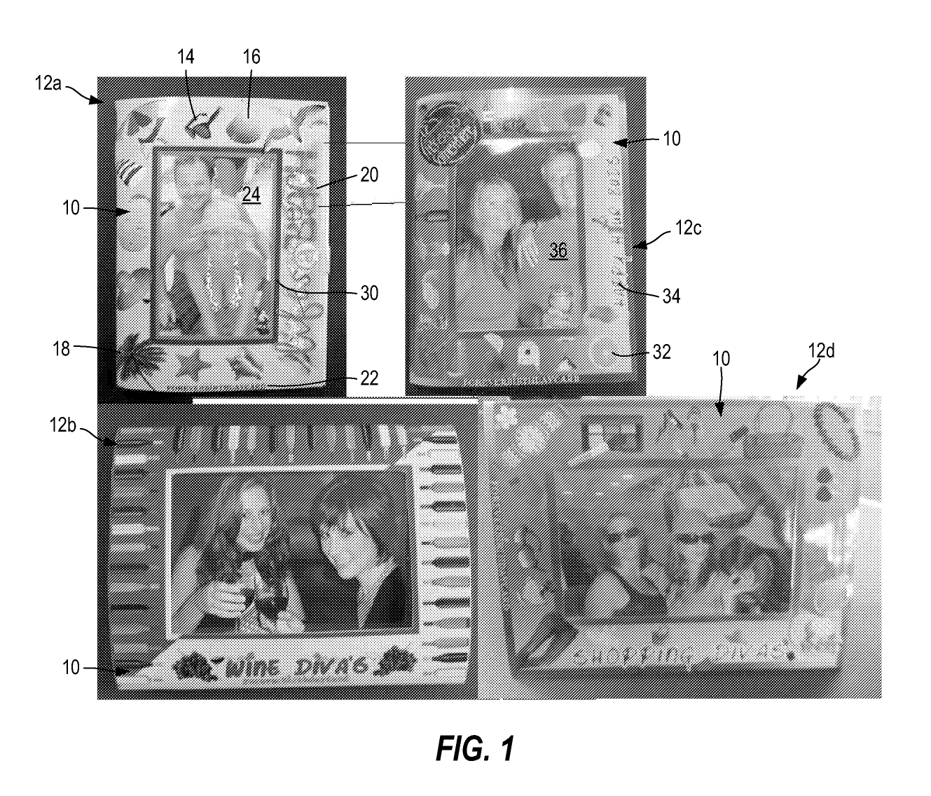

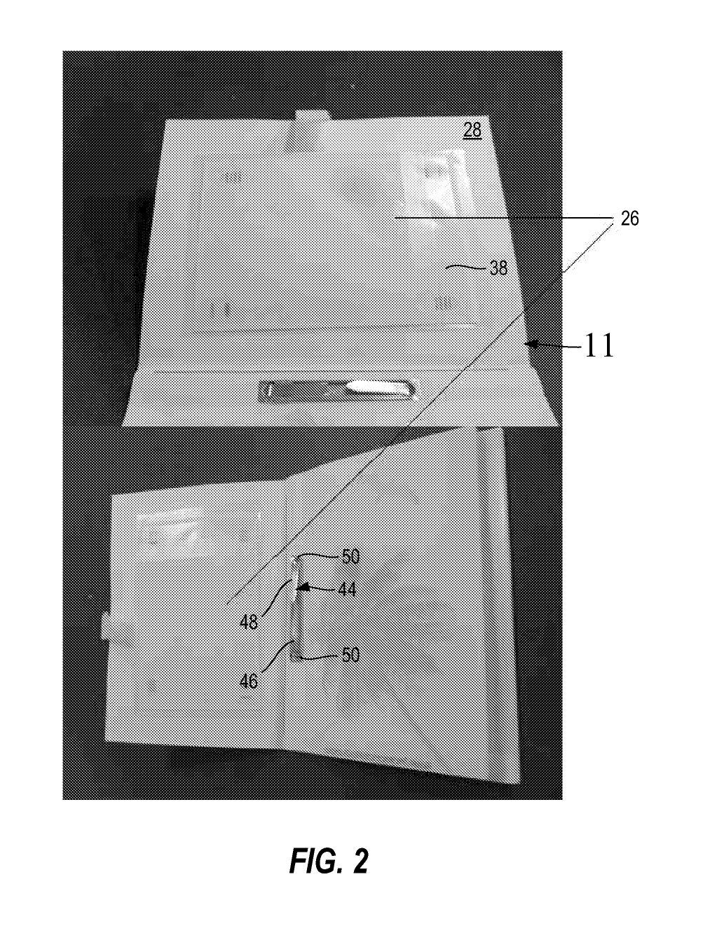

FIG. 1 shows illustrative examples of a reusable greeting cards 12a-12d, each comprising a forward cover 11 (FIGS. 2, 10 and 11) adorned with different decorative placards 10 having different themes. The specifically-themed greeting cards 12a-12d shown in FIG. 1 will be generally referred to herein as a greeting card 12. As shown in FIG. 1, the greeting card 12a includes a forward cover 11 adorned with a decorative placard 10 having an externally-exposed surface that, when observed by a user, reveals a beach-specific theme. The decorative aspects, including text and/or graphics, used to create the different themes can be, but are not limited to being printed on the externally-exposed surface of the decorative placards 10. According to alternate embodiments, the decorative aspects can be embedded within the decorative placards 10, covered by a protective laminate for example, or otherwise provided to the decorative placards in a manner that allows the decorative aspects to be viewed when observing the externally-exposed surface thereof. For the sake of brevity, however, the decorative aspects will be described herein as being provided on the externally-exposed surface.

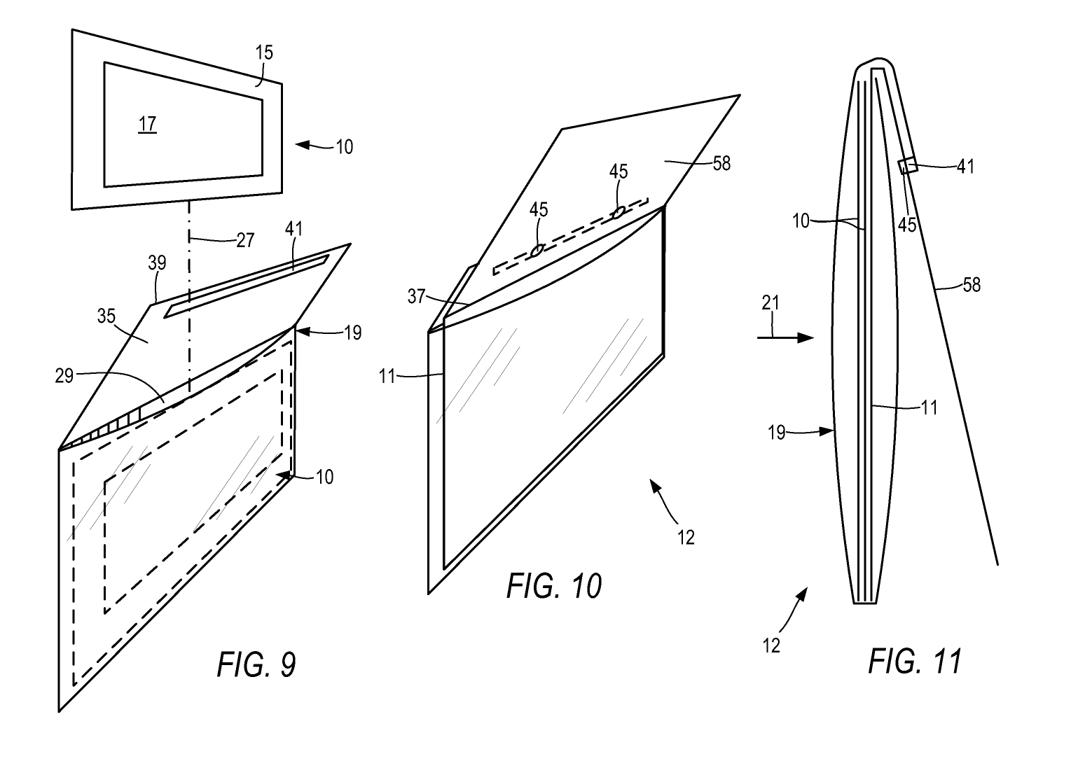

As shown in FIGS. 1 and 9, the decorative placard 10 can optionally take the form of a frame that includes a border 15 defining a window 17 through which a photograph 24 can be viewed when the externally-exposed surface of the decorative placard 10 supported adjacent to the forward cover 11 is observed. For the embodiment in FIG. 9, which provides a view of an internal side of the decorative placard 10, the border 15 of the decorative placard 10 is formed from a glossy paper sheet from which the window 17 has been cut. The inward-facing, or “back” side of the decorative placard 10 (illustrated in FIG. 9) can optionally be blank, can optionally be adorned with text and/or graphics that are different than the text and/or graphics adorning the outward facing, or “front” side of the decorative placard 10 to create a different decorative theme (i.e., the decorative placard 10 can be flipped to provide a different decorative theme to the greeting card 12 when viewed from the outside), and/or can optionally be provided with a pressure-sensitive adhesive covered by a release layer that protects the adhesive until the release layer is removed when the decorative placard 10 is to be adhesively applied to the forward cover 11. The adhesive embodiment of a support for supporting the decorative placard 10 adjacent to the externally-exposed side of the forward cover 11 is said to interchangeably receive the decorative placard 10 because it allows the user to apply the decorative placard 10 to the forward cover 11. When the user desires to change the theme of the greeting card 12, the user can adhesively apply a new decorative placard over the existing decorative placard 10 applied to the forward cover 11.

Instead of an adhesive, the support for supporting the decorative placard 10 adjacent to the forward cover 11 can include a sleeve 19 that can receive one, or a plurality of the decorative placards 10 therein through an aperture 29, as shown in FIG. 9 (the decorative placard 10 deposited along axis 27 into the sleeve 19 through the aperture 29 is shown in broken lines). The decorative placard(s) 10 received within the sleeve 19 are held in place in front of the forward cover 11, which is also received within the sleeve 19 as shown in FIG. 10. Thus, the decorative aspects of the forward-most decorative placard 10 in the sleeve 19 are visible in front of the forward cover 11 through the sleeve 19 when observed by a viewer in the direction indicated by arrow 21, as shown in FIG. 11, thereby establishing the theme of the greeting card 12. Spare or replacement decorative placards 10 can be stored behind (i.e., to be concealed from view by the viewer who is observing the externally-exposed surface of the forward-most decorative placard 10 in the sleeve 19) the forward-most decorative placard 10, behind the front cover 11, or both.

The sleeve 19 can be formed from any substantially-transparent material, such as clear vinyl, clear polypropylene, etc. . . . , and can have interior dimensions that closely approximate the exterior dimensions of the forward cover 11. Accordingly, the forward cover 11 is snugly received within the sleeve 19 as shown in FIG. 10.

To interfere with the removal of items such as the decorative placard(s) 10 within the sleeve 19, the sleeve 19 can include a flap 35 that is to extend over a binding region 37 coupling the forward cover 11 to a rearward cover 58 of the greeting card 12 when the forward cover 11 is fully inserted into the sleeve 19. The flap 35 is to extend at least partially along the rearward cover 58, and optionally include a closure device that maintains the flap 35 in a closed state over the binding region 37 to interfere with removal of items from within the sleeve 19. The binding region 37 can include one or more simple folds in a continuous sheet of material, bound ends of a plurality of sheets of material, a mechanical binder coupling separate forward and rearward covers 11, 58 together, and the like.

For the embodiment shown in FIGS. 9 and 10, the closure device includes a first one of a magnet and a magnetic material provided to the distal end 39 of the flap 35. The other one of the magnet and the magnetic material is provided to the rearward cover at a location where the portion of the closure device provided to the flap 35 is positioned when the flap 35 is in the close state. As specifically shown in the embodiment of FIGS. 9 and 10, a magnet or magnetic receptive material 41 extends along the distal end 39 of the flap 35, and a pair of metallic members 45 are embedded within, or otherwise provided to the rearward cover 58. Of course other embodiments include the magnet or magnetic receptive material 41 provided to the rearward cover 58, and the metallic member 45 provided to the flap 35. Regardless of the relative arrangement, a magnetic attraction between the magnet 41 and the metallic members 45 maintains the flap 35 in the closed state.

Although described and shown herein as a frame, the decorative placard 10 bearing the decorative aspects can optionally be a decorative sheet without the window 17 arranged forward of the forward cover 11, a decal adhesively applied to an external surface of the forward cover 11, and the like.

Graphics such as a pair of sunglasses 14, seashell 16, palm tree 18 or any other images consistent with the beach-specific theme can appear on the decorative placard 10 provided to the greeting card 12a in FIG. 1. The graphics appearing on the externally-exposed surface of the forward cover 11 can optionally be user selectable from a menu of available graphics on a website for ordering and optionally customizing the greeting card 12, can be photographic images uploaded by the user to the website, can be locally-stored images on the user computer and output via a local printer onto blank decorative placards 10 for example, or any suitable image downloaded to the user computer over a communication network described below. According to alternate embodiments, the decorative aspects can optionally include stock or generic graphics and/or text, pre-printed by a supplier of the decorative placards 10. Thus, the generic decorative placards 10 can optionally be purchased for a variety of general themes such as birthdays, anniversaries, graduations, holidays, etc. . . .

The externally-exposed surface of the forward cover 11 can also include optional text 20, and can optionally be consistent with the theme of the greeting card 12a. For the illustrative example of the greeting card 12a, the text 20 reading “Life's a Beach” is consistent with the beach-specific theme. Like the graphics, the text 20 can optionally include a slogan available for selection on a website, optionally be keyed into the website by a user customizing the greeting card 12a, can be locally keyed by the user into a user computer for local printing of the content appearing on the externally-exposed surface of the forward cover, or otherwise specified by the user.

Advertising text 22 can also optionally be included on the externally-exposed surface of the forward cover 11 and/or the decorative placard 10. As shown in FIG. 1 for the greeting card 12a, the text “FOREVERBIRTHDAYCARD” identifying a proprietary of the greeting card 12a appears on the externally-exposed surface of the placard 10. Such advertising text 22 can optionally appear elsewhere within the greeting card 12a in addition to, or instead of, on the externally-exposed surface of the forward cover 11. Other embodiments include advertising text 22 comprising a uniform resource locator (“URL”) of a website on which a user can purchase the greeting card 12a, and optionally customize it to the user's preferences as described below.

Although the text and graphical items are described above as being printed or otherwise pre-applied onto the externally-exposed surface of the placard 10 and/or forward cover 11 when the greeting card 12 is purchased and customized, the externally-exposed surface can optionally include one or more regions where a user can hand write a short note. Likewise, any of the graphical items described as appearing on the externally-exposed surface of the forward cover 11 can be permanently adhered, printed or otherwise applied decorations; or removable stickers adhered to the placard 10 and/or the forward cover 11 by the user. The stickers can optionally be included as part of a package that is purchased in combination with, or in addition to the greeting card 12 with which the user can customize the greeting card 12.

The greeting card 12 can optionally be provided with a photograph mount so that a photograph 24 can be the provided to the greeting card 12a by a user in a manner to be visible when the externally-exposed surface of the forward cover 11 is being viewed. For the embodiment shown in FIG. 2, a sleeve 26 formed from a substantially transparent material is coupled to in inward-facing surface 28 of the forward cover 11. The sleeve 26 can be fastened to the inward-facing surface 28 within he says, tape, adhesive or any other suitable fastener. The sleeve 26 is positioned to span in all dimensions over the window 17 defined by a border 30 (FIG. 1) through which the photograph 24 placed in the sleeve 26 can be viewed. The sleeve 26 can optionally include a Ziploc feature, a closable flap 38, or any other retaining feature that can selectively interfere with the removal of the photograph 24 from the sleeve 26.

According to alternative embodiments, so-called picture corners comprising pockets extending in two directions that are arranged at 90° angles relative to each other can optionally be provided to the forward cover 11 to couple the photograph 24 to the greeting card 12. According to alternative embodiments the photograph 24 can be secured in place with an adhesive, tape or any other suitable fastener, or corners of the photograph 24 can be inserted through slots formed in the forward cover 11 through which the four corners of the photograph 24 can be inserted. Yet other embodiments can include the contents of the photograph 24 printed directly onto the forward cover 11.

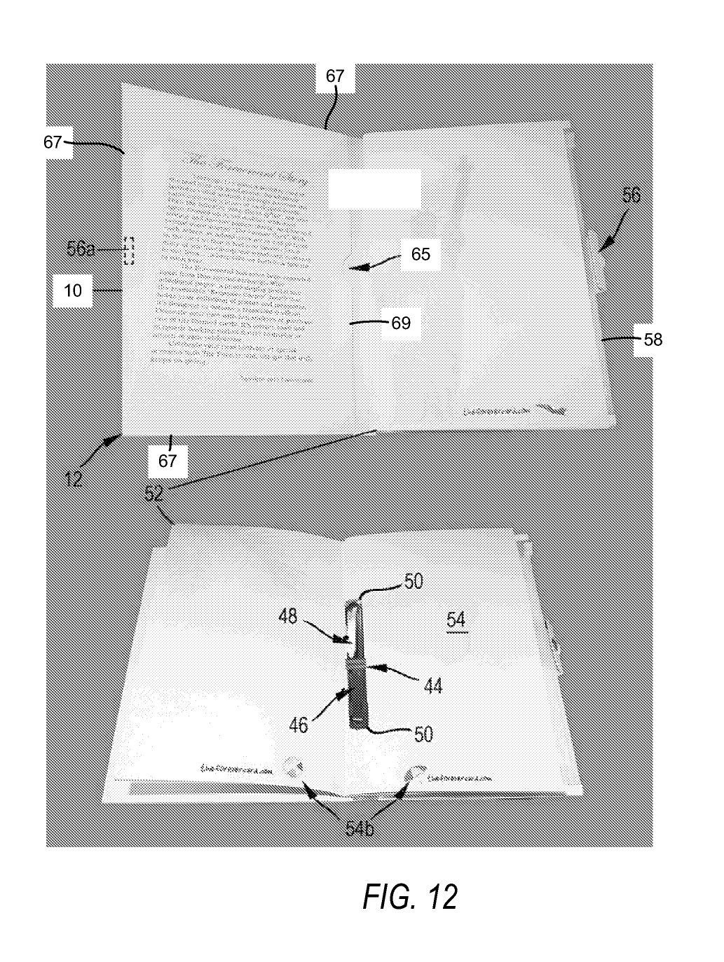

An alternate embodiment of the greeting card 12 is shown in FIG. 12. As shown, the greeting card 12 includes a forward cover 11 formed with an integral gap 65 that is accessible from an inward-facing side 67 of the forward cover 11. The gap 65 can optionally be formed between opposing portions of the forward cover 11, and can be provided in place of the sleeve 26 to receive photographs 24 or other objects. For example, an additional segment of the material forming the forward cover 11 can joined on three sides 67 to a portion of the forward cover 11 forming the externally-exposed surface. The fourth side 69 can remain separate (unjoined) to the portion of the forward cover 11 forming the externally-exposed surface, thereby establishing a pocket as the gap 65 there between for receiving objects such as the photograph 24, for example. According to such an embodiment, the forward cover 11 with the gap 65 can then be inserted into the sleeve 19 as described above as shown in FIGS. 9-11, thereby positioning a photograph disposed received in the gap 65 within the window 17 defined by the border 15. Thus, when the externally-exposed surface of the forward cover 11 is viewed, the photograph 24 in the gap 65 is visible through the window 17 defined by the border 15.

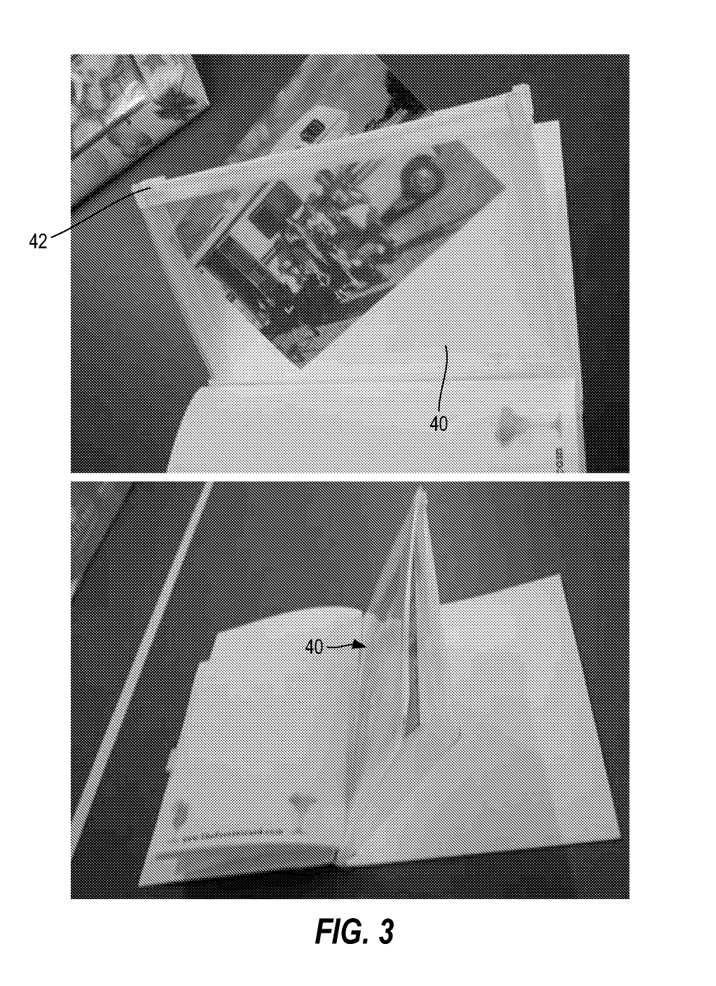

FIG. 3 shows an illustrative example of an expandable storage pouch 40 that can be provided to the greeting card 12 for storing one or more items to be conveyed between a sender and a recipient with the greeting card 12. The storage pouch 40 can be formed from a substantially-transparent material and, like the sleeve 26, can optionally include a retaining feature, also referred to as a closing mechanism, such as a Ziploc 42, foldable flap, or any other feature operable to close the storage pouch 40 and retain the elements therein. Adjustment of the closing mechanism in one manner can close the storage pouch 40, thereby interfering with the removal of any contents contained within the storage pouch 40. Likewise, the closing mechanism can also be adjusted to open the storage pouch 40, thereby granting access to an interior thereof and any contents disposed within the storage pouch 40. Accordingly, the storage pouch 40 can be repeatedly opened and closed through operation of the closing mechanism. The storage pouch 40 can be disposed of any desired location within the greeting card 12, and the desired location can optionally be changed from time to time by the user at desired. For example, the storage pouch 40 can optionally be retained within the greeting card 12 by a releasable clasp 44, shown in FIG. 2. The illustrative example of the releasable clasp appearing in FIG. 2 includes two prongs 46, 48 that extend through apertures 50 formed in the material to be secured within the greeting card 12. Once the prongs 46, 48 extend through the apertures 50, the prongs 46, 48 are folded inwardly to thereby interfere with removal of the serial defining the apertures 50. However, the two-prong releasable clasp 44 is described merely an illustrative example, and any suitable fastener that can secure material within the greeting card 12 and selectively be adjusted to release the material for removal or to receive and secure additional material within the greeting card 12 can be used.

Greeting card 12a appearing in FIG. 1 as a beach-specific theme, however the user customizing the greeting card can select any desired theme other than a beach-specific theme. For example greeting card 12b in FIG. 1 has a wine theme possibly to commemorate a memorable wine tasting that was attended by friends who will contribute to the customization of the greeting card 12b. Greeting card 12c has a happy-hour theme possibly to remind the recipient(s) of the greeting card 12c of a memorable evening out together. Like the greeting card 12a, the greeting card 12c includes graphical items 32, text 34, and a photograph 36 that are all consistent with a happy hour. The user may also create their own themed card by starting with a blank placard 10, forward cover 11 or other displayed surface and then adding their own theme thru the application of graphics and stickers. The stickers or covers can replace whenever desired to create a new theme, but the pages and writing content inside remain as a diary keepsake. For example a parent may purchase a card for their young son and add Mickey Mouse stickers for a Disney theme originally. Then as the child gets older change the card's theme to a sports theme by replacing the entire cover or just the stickers, on the cover, to footballs, baseballs or other sporting related items.

As shown in FIG. 1, greeting cards 12a and 12c include text such as the advertising text 22 and photographs 24 and 36 oriented in a portrait orientation. Greeting cards 12b and 12d include text and their respective photographs in a landscape orientation.

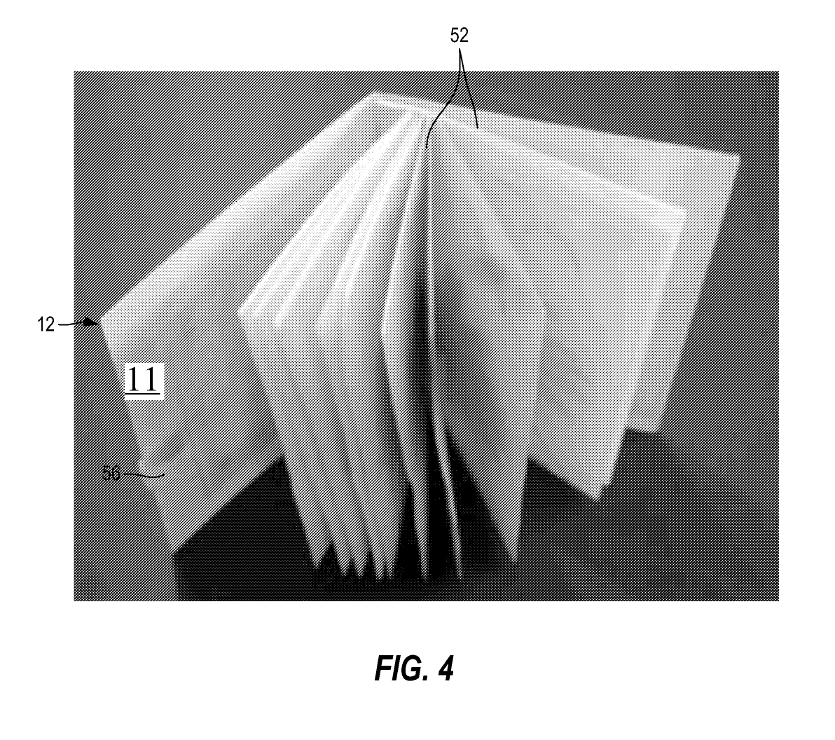

FIG. 4 shows an illustrative embodiment of the greeting card 12 including a plurality of content pages 52 secured to the greeting card 12 by the releasable clasp 44 or other suitable releasable fastener provided to the binding region 37. The forward cover 11 can be secured to the greeting card 12 using the releasable clasp 44 or other suitable releasable fastener enabling a different theme to be displayed. The content pages 52 can include sheets of paper or any other medium on which the user can hand write, print or otherwise apply content such as a personalized message that is to be delivered to the recipient of the greeting card 12. The plurality of content pages 52 provide adequate space for a lengthy back-and-forth between the parties who send and receive the greeting card 12 to each other via the postal system or other physical-delivery courier. Thus, the greeting card 12 can serve as a journal shared between the multiple parties who will receive the greeting card 12.

FIG. 2 shows an embodiment of a content page 52 that includes a themed background 54. As shown, the background 54 appears as a partially transparent image over which the handwritten or otherwise applied content is to be applied by the users. One example of the background 54 is what is commonly referred to as a watermark. The watermark for the embodiment in FIG. 2 near the bottom of the content pages 52 is also consistent with a beach theme and includes similar beach themed graphics 54b along the bottom of the pages. Such a watermark is consistent with the “Life's a Beach” themed greeting card 12a Shown in FIG. 1. According to alternative embodiments, the content pages 52 can include a substantially-uniform, and optionally white or other solid-color surface on which users can elect to write or otherwise apply their personalized notes to each other.

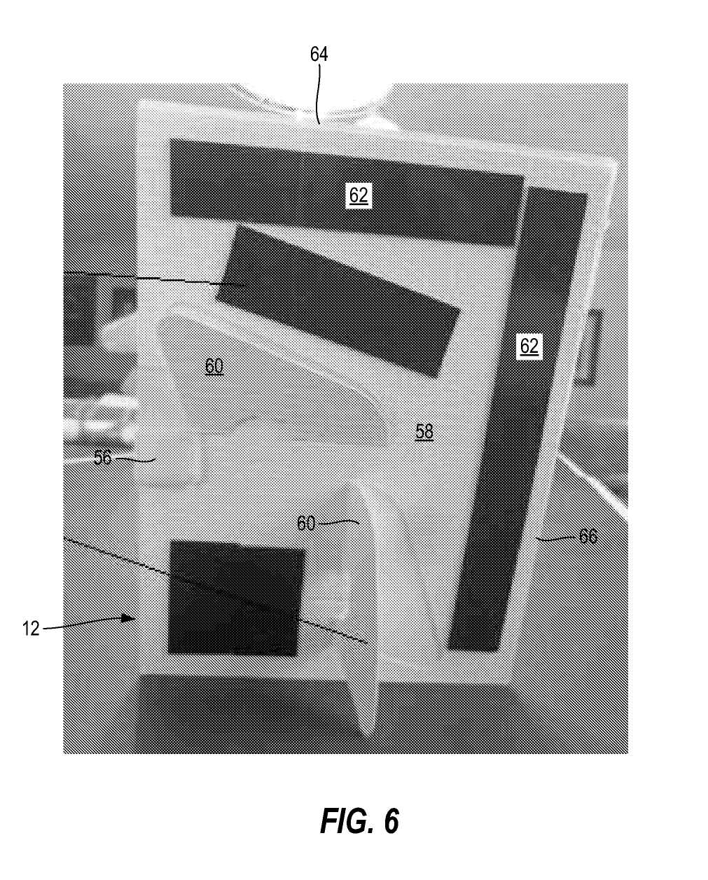

Referring once again to FIGS. 4 and 12, the greeting card 12 can optionally include an apendage 56 that can cooperate with a compatible receiver that is attached to, embedded within or otherwise hidden inside the forward cover 11 to maintain the rearward cover 58 and forward cover 11 in a closed state. For the embodiment shown in FIG. 4, the tether 56 can include a strap provided with a button snap, hook-and-loop material offered under the trade name Velcro®, or a first portion of any other suitable fastener. To hold the greeting card 12 closed, the strap of the present embodiment is extended behind the rearward cover 58 as shown in FIG. 6, and the button snap, hook-and-loop material or first portion of any other suitable fastener is mated with a compatible, second portion of that fastener supported on the rearward cover 58. Connected in this manner, the tether 56 maintains the forward cover 11 in close proximity to the rearward cover 58 to keep the greeting card 12 in the closed state. Alternate embodiment of the tether 56 can include a string extending from the forward cover 11 that can be wrapped around a post extending from the rearward cover 58. Any other suitable structure for maintaining the forward cover 11 within close proximity to the rearward cover 58 can also be employed without parting from the scope of the present invention.

For the embodiment shown in FIG. 12, the appendage 56 extending from the rearward cover 58 can be provided with a magnet or magnetic receiver (i.e., a material to which a magnet is attracted), and the other one of the magnet or magnetic receiver can be provided to the forward cover 11. As shown in the present embodiment, the appendage 56 is a magnetic appendage, or includes a magnet coupled thereto. The magnetic receiver 56a, is embedded or otherwise concealed from view by the material forming the forward cover 11. When the forward and rearward covers 11, 58 are brought within close proximity to each other, thereby being placed in the closed state, the magnetic appendage 56 can be magnetically coupled to the magnetic receiver 56a to maintain the forward and rearward covers 11, 58 in the closed state.

FIG. 6 also shows an illustrative embodiment of a plurality of easel supports 60 that are pivotal from the rearward cover 58 to prop the reusable greeting card 12 in an upright orientation. Generally, each easel support 60 is adjustable between a stowed orientation where the easel does not significantly protrude outwardly from the rear cover to allow the greeting card to be laid flat on a major plane of the rearward cover 58, and a deployed orientation where the easel protrudes outwardly, generally away from the major plane of the rearward cover 58 to prop the greeting card 12 in a generally upright orientation. At least one of the easel supports 60 can optionally be arranged at a 90° angle relative to another of the easel supports 60 to prop the greeting card 12 generally upright in a portrait orientation as well as a landscape orientation. The rearward cover 58 shown in FIG. 6 also includes a plurality of hangers 62 for hanging the reusable greeting card 12 from a supporting surface. For example, the illustrative embodiment of the rearward cover 58 shown in FIG. 6 includes a plurality of hangers 62 in the form of magnets. The magnets can be distributed across a substantial portion of the extent of the rearward cover 58 to ensure a suitable magnetic force to support the greeting card 12 on a vertically-oriented supporting surface that is made of, or adjacent to a ferromagnetic material. For instance, the greeting card 12 can be magnetically coupled to a magnetically-attractive portion of a refrigerator or other home appliance. According to alternative embodiments, a magnet can extend along a border adjacent to a top 64 of the greeting card 12 when arranged in a portrait orientation, and another magnet extending along a border 66 that is at the top of the greeting card 12 when oriented in a landscape orientation.

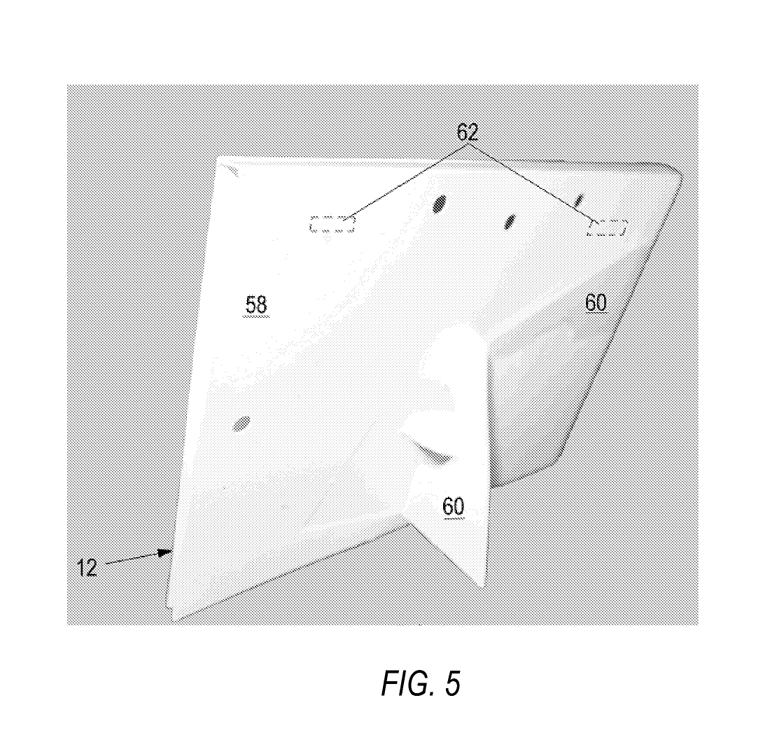

Another embodiment of the rearward cover 58, shown in FIG. 5, also includes a plurality of hangers 62 for hanging the reusable greeting card 12 from a supporting, magnetically-attractive surface. For example, the hangers 62 of the illustrative embodiment shown in FIG. 5 are magnets. The magnets (represented in broken lines) can be embedded within, coupled to an inward-facing surface of, or otherwise concealed from view when the rearward cover 58 is viewed externally of the greeting card 12, to ensure a suitable magnetic force to support the greeting card 12 on a substantially-vertical metal surface. However, in the present embodiment, they are hidden inside the greeting card 12 to improve the aesthetic appearance thereof.

The greeting card 12 can optionally be sized for transit from a sender to a recipient through the U.S. postal service or other suitable courier. For example, the forward cover 11 can be substantially rectangular in shape, and have a length in a major plane of about nine (9″) inches or less, and a height in the major plane of about six (6″) inches or less. The major plane of the forward cover 11 can be considered, for purposes of the measurements set forth for the present embodiment, to be the plane viewed when observing the externally-exposed surface of the forward cover 11 (i.e., as observed in FIG. 1). According to other embodiments, however, the forward cover 11 can have any desired dimensions without departing from the scope of the present invention.

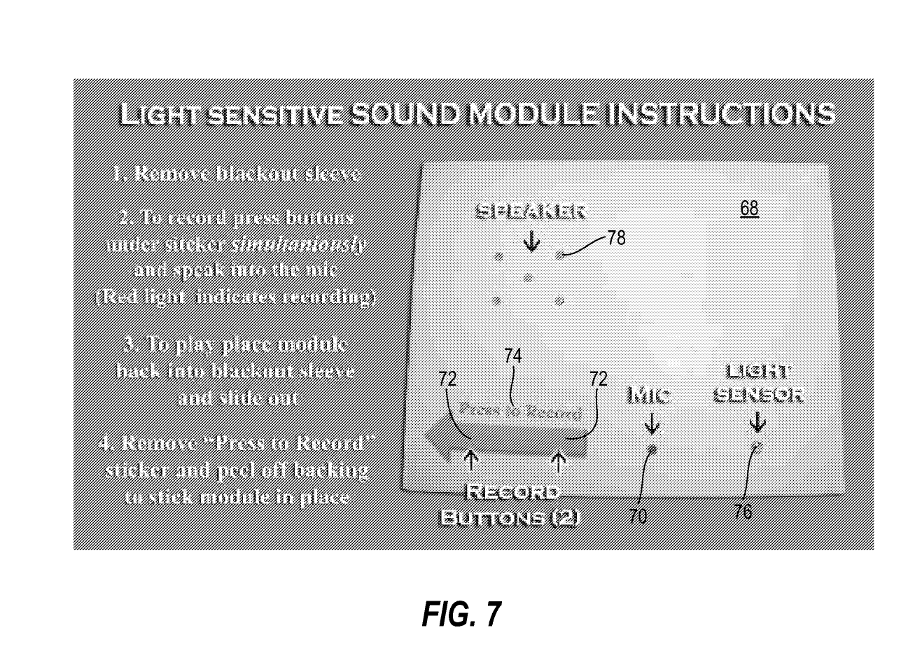

FIG. 7 shows an illustrative embodiment of an audio page 68 that allows a user to record a custom, audible message to be played back to a recipient of the card 12. The audio page 68 can be built into the card or formed as a rigid cardboard or plastic placard that can be Velcro inside or inserted and removed from the storage pouch 40, for example, can optionally include apertures 52 cooperate with the two prongs 46, 48 of the releasable clasp 44, or can be secured to the card 12 in any desired manner. The audio page 68 can optionally include an electronically-erasable programmable read-only memory (“EEPROM”), or other suitable non-transitory, computer-readable memory for storing audio data or an audio file comprising the audible message recorded by the user. The illustrative embodiment of the audio page 68 shown in FIG. 7 includes a microphone 70 for receiving the message spoken by the user in converting that spoken message into an electronic signal. The electronic signal conveys electronic data making up the audible message that is to be stored in the non-transitory, computer-readable memory. A microprocessor executing computer-executable instructions were other suitable controller can be provided to the audio page 68 to control the recording and playback of the audible message into and from the memory.

To record an audible message, the user can press a single record button, or concurrently (or optionally, simultaneously) press a plurality of record buttons 72 as shown in the illustrative embodiment. The use of a plurality of record buttons 72 can minimize the likelihood that a recording operation will be unintentionally initiated, possibly resulting in a stored message being accidentally recorded over. The record buttons 72 can be concealed by a decorative overlay including an instructional phrase 74 such as “Press to Record” as shown in FIG. 7. A light 76 can be provided to the audio page 68 to indicate when a recording operation is underway. The light 76 can optionally blink, remain on constantly for as long as a recording operation is underway, or otherwise be illuminated to indicate that a message is being recorded. A speaker 78 is also provided to audibly broadcast to reproduce a message stored in the memory. Reproduction of the message can be initiated by recipient opening the card allowing light hits the light sensor 76 or by opening the card which activates a play button or switch (not shown).

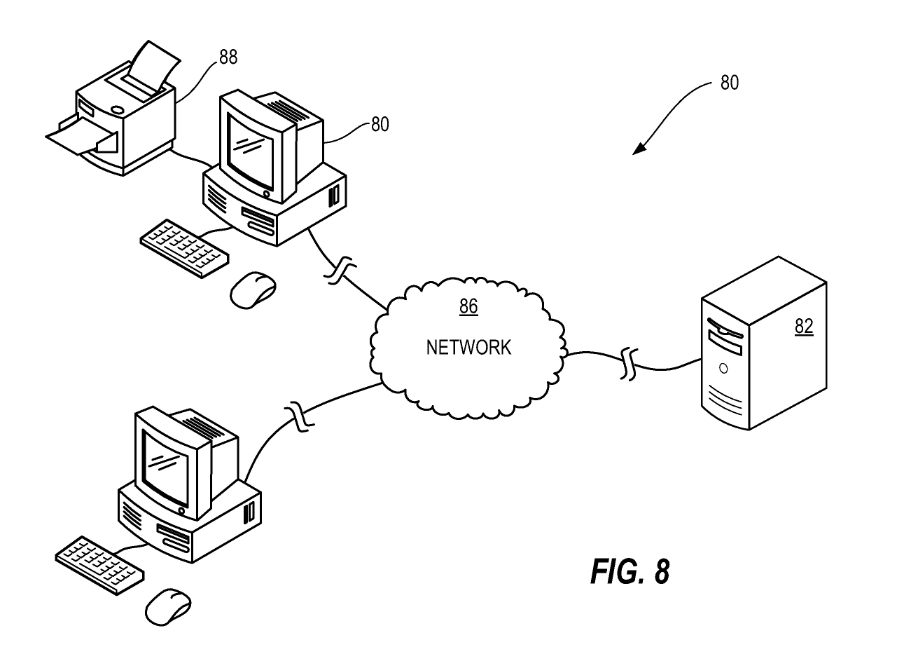

FIG. 8 shows an illustrative embodiment of a computer system 80 that can be used to customize, create and/or purchase the card 12 as well as purchase accessories for the cards such as stickers or additional supplies. As shown, the computer system 80 includes a server 82 hosting a website that can be accessed by a user via a user computer 84 over a communication network 86. The website hosted by the server 82 can optionally include electronic store allowing the user to customize various aspects of the card 12 as described above. For example, the website can allow the user to select, upload or otherwise customize the graphical items that are to appear on the externally-exposed surface of the forward cover 11. The communication network 86 can include a local area network, a wide area network such as the Internet, or a combination thereof. The user computer 84 can be a personal computer or other general-purpose computer, and can optionally be operatively connected to a printer 88. The printer 88 can optionally be used corny to various embodiments to locally print content appearing anywhere on the card 12.

According to alternate embodiments, the website can allow the user to download suitable software that, when executed by the user computer 84, presents the user with the various design options described herein to locally create the card 12. Yet other embodiments include a non-transitory computer-readable medium storing computer-executable instructions that, when executed by the user computer 84 allow the user to customize and generally create the card 12.

Regardless of how the card 12 is created, the user can select a photograph 24 to be sent to a recipient, can optionally store additional items such as concert tickets, or other memorabilia in the storage pouch 40, record an audible message using the audio page 68, and/or hand write a customized message to the recipient on one of the plurality of content pages 52. The card 12, when closed, can have a thickness comparable to that of a small pamphlet, allowing the greeting card 12 to be inserted into an envelope and physically transported to the recipient by a postal service or other courier. Due to the customizable and expandable nature of the card 12, the recipient can elect to add to and/or change the content of the card 12 such as the photograph 24, the hand written note on the content pages 52, and/or items in the storage pouch 40. The recipient can then package the updated card 12 in an envelope, addressed the envelope and send the card 12 to a desired recipient may be the original sender. Users may also choose to keep the card as a way to remember holidays, parties or special events. For a Thanksgiving card example you could ask everyone that came and visited you to pose for a photograph and perhaps write something before signing the card. Then each year you can look back at who attended and read the comments about your delicious stuffing that year.

Another e-card software solution is an application that can be downloaded and ran on various Smart Phones such as the iPhones, from Apple. Unlike present birthday e-cards which are meant to be sent once then eventually erased, this unique e-card would remember each the user's well wishes each year, on a server 82 thus creating a diary of well wishes that are shared back and forth thru the years. For example Lisa can send Debbie a Birthday well wish message that reads “Happy Birthday Deb, This is the year you moved into your new apartment and rescued your new dog Riley from the kennel (2011). The app can remind you when birthdays are coming up and can allow more than one user to share the e-card. Advertising may be provided on the app or website to help pay for the server storage space or an annual fee may be charged. The app would allow the users to customize the e-card by picking from a selection of birthday e-cards and adding photographs to customize before sending.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used herein, such term is intended to be inclusive in a manner similar to the term “comprising” as “comprising” is interpreted when employed as a transitional word in a claim.

I claim:

1. A reusable greeting card including an adaptable theme, the reusable greeting card comprising:
a forward cover;
a replaceable decorative placard comprising an externally-exposed surface that is to be outwardly displayed adjacent to the forward cover to be viewable by a viewer observing the greeting card, wherein the decorative placard comprises a decoration specific to a theme of the greeting card;
a support that interchangeably receives the decorative placard and at least a second decorative placard to be outwardly displayed adjacent to the forward cover, the second decorative placard comprising a second decoration specific to a second theme that is different from the theme of decorative placard; and
a plurality of writing pages on which customized greeting content is to be applied by a user, wherein said writing pages are at least partially concealed from view by said forward cover.

2. The reusable greeting card of claim 1 further comprising a cover connector that maintains a proximate relationship between the forward cover and the rearward cover when the greeting card is in a closed state, wherein said cover connector comprises a magnet provided to one of the forward cover and the rearward cover, and a magnetic material provided to another of the forward cover and the rearward cover.

3. The reusable greeting card of claim 1 further comprising:
a storage pouch that stores physical objects to be conveyed within the greeting card between a sender of the greeting card and a recipient of the greeting card; and
a releasable fastener that couples the writing pages and the storage pouch to the forward cover, wherein said releasable fastener is adjustable to receive and couple additional writing pages to the greeting card.

4. The reusable greeting card of claim 1 further comprising a photograph mount adapted to receive a photograph and support the photograph in a position that is viewable by the viewer while observing the externally-exposed surface of the decorative placard received by the support, wherein the decorative placard comprises a frame that extends at least partially about the photograph while the photograph is received by the photograph mount and the forward cover is in a closed position.

5. The reusable greeting card of claim 1 further comprising a plurality of additional frames that are each interchangeably receivable by the support and comprise an externally-exposed surface decorated specific to a different theme, wherein the support comprises a sleeve provided to the forward cover that concurrently stores all of the frames adjacent to the forward cover.

6. The reusable greeting card of claim 5, wherein the sleeve is substantially transparent to allow viewing of the externally-exposed surface of the frame specific to the current theme of the greeting card when the frame is disposed within the sleeve.

7. The reusable greeting card of claim 6, wherein the sleeve comprises:
an aperture into which the forward cover extends to enter the sleeve;
a flap that extends over a binding region coupling the forward cover to the rear cover of the greeting card when the forward cover is fully inserted into the sleeve; and
a closure device that maintains the flap in a closed state over the binding region to interfere with removal of the forward cover, the frame and each of the additional frames from within the sleeve.

8. The reusable greeting card of claim 7, wherein the closure device comprises a first one of a magnet or magnetic receptive material provided to the flap adjacent to a distal end of the flap, and the rearward cover comprises a second one of the magnet and the magnetic material, wherein a magnetic attraction between the first one and the second one of the magnet and the magnetic material maintains the flap in the closed state.

9. The reusable greeting card of claim 4, wherein the externally-exposed surface of the frame comprises an advertisement that is independent of the current theme of the greeting card.

10. The reusable greeting card of claim 1 further comprising a magnet that establishes a suitable magnetic attraction between the greeting card and a ferromagnetic material to support the greeting card on the ferromagnetic material.

11. The reusable greeting card of claim 1 further comprising:
a rearward cover separated from said forward cover by said writing pages; and
an easel that is adjustably coupled to the rearward cover, wherein the easel is adjustable between:
a stowed orientation where the easel does not significantly protrude outwardly from the rear cover to allow the greeting card to be laid flat on a major plane of the rearward cover, and
a deployed orientation where the easel protrudes outwardly, generally away from the major plane of the rearward cover to prop the greeting card in a generally upright orientation.

12. A reusable greeting card comprising:
a forward cover;
a photograph mount adapted to receive a photograph and support the photograph adjacent to the forward cover in a position to be viewed during observation of the forward cover in a closed orientation;
a plurality of writing pages on which customized greeting content is to be applied by a user, wherein said writing pages are at least partially concealed from view by said cover;
a rearward cover at least partially separated from said forward cover by said writing pages while the greeting card is in a closed state; and
a magnet coupled to the rearward cover, wherein the magnet establishes a suitable magnetic attraction between the greeting card and a vertically-oriented ferromagnetic material to couple the greeting card to the ferromagnetic material.

13. The reusable greeting card of claim 12 further comprising an easel that is adjustably coupled to the rearward cover, wherein the easel is adjustable between a stowed orientation and a deployed orientation where the easel extends outwardly, generally away from a major plane of the rearward cover to support the greeting card in a generally-upright orientation.

14. The reusable greeting card of claim 12 further comprising an advertisement appearing on an externally-exposed surface of the forward cover.

15. The reusable greeting card of claim 12, wherein the forward cover is substantially rectangular in shape, and comprises a length in a major plane of about 9 inches or less, and a height in the major plane of about 6 inches or less.

16. The reusable greeting card of claim 12 further comprising a sleeve that receives at least a portion of the forward cover and a replaceable decorative placard decorated in a manner specific to a theme to be established for the greeting card.

17. The reusable greeting card of claim 16, wherein the forward cover comprises a window through which the photograph received by the photograph mount is viewable, and the decorative placard comprises a frame that extends at least partially about the window.

18. The reusable greeting card of claim 12, wherein the frame comprises an advertisement that is viewable during observation of the forward cover.

19. The reusable greeting card of claim 12 further comprising a releasable fastener coupling the writing pages to the forward cover, wherein said releasable fastener is adjustable to receive and couple additional writing pages to the greeting card.

20. A reusable greeting card comprising:
a forward cover;
a replaceable decorative placard comprising an externally-exposed surface that is to be outwardly displayed adjacent to the forward cover to be viewable by a viewer observing the greeting card, wherein the decorative placard comprises a decoration specific to a theme of the greeting card;
a support that interchangeably receives the decorative placard and at least a second decorative placard with a second decoration specific to a second theme that is different from the theme of decorative placard;
a plurality of writing pages on which customized greeting content is to be applied by a user, wherein said writing pages are at least partially concealed from view by said forward cover;
a rearward cover coupled to said forward cover and at least partially separated from said forward cover by said writing pages while the greeting card is in a closed state; and
a storage pouch that stores physical objects to be conveyed within the greeting card while in transit between a sender of the greeting card and a recipient of the greeting card, the storage pouch comprising a closing mechanism that is adjustable to allow repeated opening and closing of the storage pouch.
